(19) United States
(12) Patent Application Publication
(10) Pub. No.: US 2004/0258212 A1
(43) Pub. Date: Dec. 23, 2004

(54) Method and device for debugging an xdsl line card

(76) Inventors: Stephane Binde, Baierbrunn (DE); Chlodwig Neuhauser, Worthsee (DE); Franz Schmoller, Germering (DE); Michael Stegherr, Neubiberg (DE)

Correspondence Address: Siemens Corporation, Intellectual Property Department, 170 Wood Avenue South, Iselin, NJ, 08830, US

(21) Appl. No.: 10/496,249

(22) PCT Filed: Nov. 14, 2002
(86) PCT No.: PCT/DE02/04224

(30) Foreign Application Priority Data
Nov. 22, 2001 (DE) 10157219.0

(51) Int. Cl. H04M 1/24; H04M 3/08; H04M 3/22

(52) U.S. Cl. 379/1.03; 379/22

(57) ABSTRACT

The invention relates to a method and a device for debugging xDSL line cards. An electrical connection is established by means of a test bus, between a line port to be tested and a testing line port which can be operated in the upstream and downstream direction with the same bandwidth. The testing line port is charged with a software which simulates a subscriber-side modem, and the successful establishment of a connection between the line ports represents a function confirmation for the line port to be tested.

### CROSS REFERENCE TO RELATED APPLICATIONS

This application is the US National Stage of International Application No. PCT/DE02/04224, filed Nov. 14, 2002 and claims the benefit thereof. The International Application claims the benefits of German application No. 10157219.0 filed Nov. 22, 2001, both of the applications are incorporated by reference herein in their entirety.

### FIELD OF INVENTION

The invention relates to a method and a device for debugging xDSL line cards, preferably once they are installed, in which case the line cards have at least one chipset which can be operated both in the upstream direction and in the downstream direction with the same bandwidth and the line cards each have at least one, preferably sixteen, line ports.

### BACKGROUND OF INVENTION

xDSL line cards, especially ADSL line cards, are generally known. When such line cards are used in a line card carriers in exchanges it can sometimes occur that connections between an end subscriber and the port of a line card cannot be established. In such a case it is necessary to find the cause of the fault. One of the problems which may be preventing the connection from being established is a faulty line card.

To exclude this possible fault it is currently necessary to connect to the test bus of a line card carrier a specific test device designed solely for executing this test in order to test the corresponding port of the line card to be debugged. This involves enormous effort since on the one hand an appropriate test device has to be kept available and on the other hand the necessary personnel must be provided for conducting these tests.

### SUMMARY OF INVENTION

It is thus the object of the invention to find a method of debugging xDSL line cards which makes it possible to simplify the testing of xDSL line cards.

This object is achieved by the features of the independent patent claims. Advantageous developments of the invention are the object of subordinate claims.

When xDSL connections are set-up data with different bandwidths in the downstream direction—from the exchange to the subscriber—and in the upstream direction—from the subscriber side to the exchange—is used. Because of this different bandwidth which is designed to be greater in the downstream direction, it is possible to transmit data at a higher rate from the exchange side to the subscriber than it is in the opposite direction from the subscriber to the exchange. The modems previously used on the subscriber side and line cards are also arranged accordingly. Thus the modems of the subscribers of an ADSL connection are suitable for understanding transmission rates in the exchange direction of 896 kbit/s and coming from the exchange of up to 8,192 Mbit/s while line cards on the exchange side understand data coming from the subscribers at up to 896 kbit/s and can transfer data to subscribers at up to 8,192 Mbit/s.

Newly developed chipsets, for example the IVAX chipset from Infineon, now allow transmission at the same rate and simultaneously with maximum bandwidth in both the upstream and the downstream direction. Line cards which are equipped with this chipset can thus transmit and understand data in both directions at up to 8,192 Mbit/s—corresponding to a bandwidth of 1.1 MHz.

The inventors have now discovered that “symmetrical” line cards with such chipsets are able to be controlled on the exchange side with appropriate software so that they can also simulate the modem of a subscriber. This means that with the appropriate software the line card which operates asymmetrically in respect of its bandwidth can reverse this asymmetry and now operate at a low data transmission rate in the direction at which it previously operated at a high rate and vice versa. The line card of the exchange side thus simulates a modem of the subscriber side

In this way it is thus possible by using at least one line card with one of these chipset which is symmetrical in respect of its bandwidth within a line card carrier to test out the other line cards installed in the carrier, by establishing a corresponding connection between the line card to be tested and the broadband line card via a test bus, in which case the broadband line card uses the appropriate software to simulate a subscriber-side modem. If a connection is to be established by such a connection between two line cards within the exchange-side card carrier, the functionality of the line card to be tested is verified and the fault must be sought either in the area of the line between subscriber and exchange side or at the subscribers themselves.

In accordance with this basic idea the inventors propose improving the method of debugging exchange-side xDSL line cards in a line card carrier with at least two line cards, where at least one line card has at least one chipset which can be operated both in the upstream direction and in the downstream direction at the same bandwidth and the line cards each have at least one, preferably sixteen, line ports.

The improvement of the method in accordance with invention now consists of establishing an electrical connection via a test bus of a line port to be tested with a further testing line port which can be operated in the upstream and the downstream direction with the same bandwidth, where the testing line port is loaded with software which simulates a subscriber-side modem. The line port to be tested is then defined as fault free if a connection is successfully established between the line ports and this confirms that the line port to be tested is functioning correctly.

This inventive method now provides the option, by inserting a line card with the appropriate bandwidth into an otherwise conventionally equipped line card carrier, of physically connecting the individual ports of line cards with the broadband line card under software control and by copying the appropriate software onto the broadband line cards for debugging the desired port in each case.

It is thus now possible, without using special test equipment, with the aid of the appropriate broadband xDSL cards, to test ports within a line card carrier by simple control of the connections via a test bus.

In accordance with the inventive idea it is possible here for both the testing line port and the line port to be tested to be located on a different line card as well as on the same line card. The first situation with the line port to be tested and the testing line port on different line cards is always necessary if the line port to be tested is located on a line card with the old conventional chipsets which have a lower bandwidth the available for their upstream side than for their downstream side. If a number of chipsets are used on a card which all have the option of operating the upstream side as well as the downstream side at the same high bandwidth, by connecting a port with a first chipset and the port with the second chipset on the same line card a type of self-test for this line card can be created.

Similar to the inventive method described above, the inventors also propose a method for debugging xDSL line cards which do not absolutely have to be installed in a line card carrier. In accordance with the invention this method proposes that a line connection of at least one line port to be tested on a first chipset with a further line port to be tested of another chipset in each case which can be operated in upstream and downstream direction with the same bandwidth, are established on the same line card, in which case the testing line port is loaded with software which simulates a subscriber-side modem and as a successful call setup represents a functional acknowledgement for the line port to be tested.

Through this type of method it is possible for example to test line cards at the end of a production process, for example by using a corresponding connector which creates a test bus and connects the individual ports of different chipsets to each other so that the one chipset can test the ports of the other chipset in each case.

In accordance with inventive idea described above, the inventors also propose a line card carrier with a plurality of xDSL line cards each with at least one, preferably with sixteen, line ports, which is improved in that it provides a test bus and a controller which optionally interconnect the line ports of the line cards and simultaneously disconnect their connection to the subscriber side for test purposes.

In addition the inventors propose an additional test matrix connector for plugging into an xDSL line card with at least two independent chipsets, for operating the line card with a higher bandwidth both in the downstream and in the upstream-direction, with the outstanding feature that at least one port of a chipset is connected to a port of another chipset. Through such a chipset it is now possible to even configure line cards which are not installed, that is those at the end of a production process for example, by plugging in said matrix connector for example, so that the ports of the one chipset are connected to the ports of the other chipset, with the first chip being operated with the software as would be used in exchange-side operation, while the other chipset contains software which simulates a subscriber-side modem, so that establishing the connection between the ports of the individual chipsets is possible. If such as connection is then positively established, this verifies that the individual ports are functioning correctly.

### BRIEF DESCRIPTION OF THE DRAWINGS

The invention is described in a more detail below on the basis of the preferred exemplary embodiments with the aid of the figures. The individual diagrams show:

FIG. 1: Prior art as regards testing out of line cards on the exchange side;

FIG. 2: Establishing a connection between a line card to be tested in a line card carrier;

FIG. 3: Establishing a connection between two ports of different chipsets on the same line card in a line card carrier;

FIG. 4: Test connector in accordance with the invention;

FIG. 5: Structure of an ADSL line card with two IVAX chipsets for eight ports each.

### DETAILED DESCRIPTION OF INVENTION

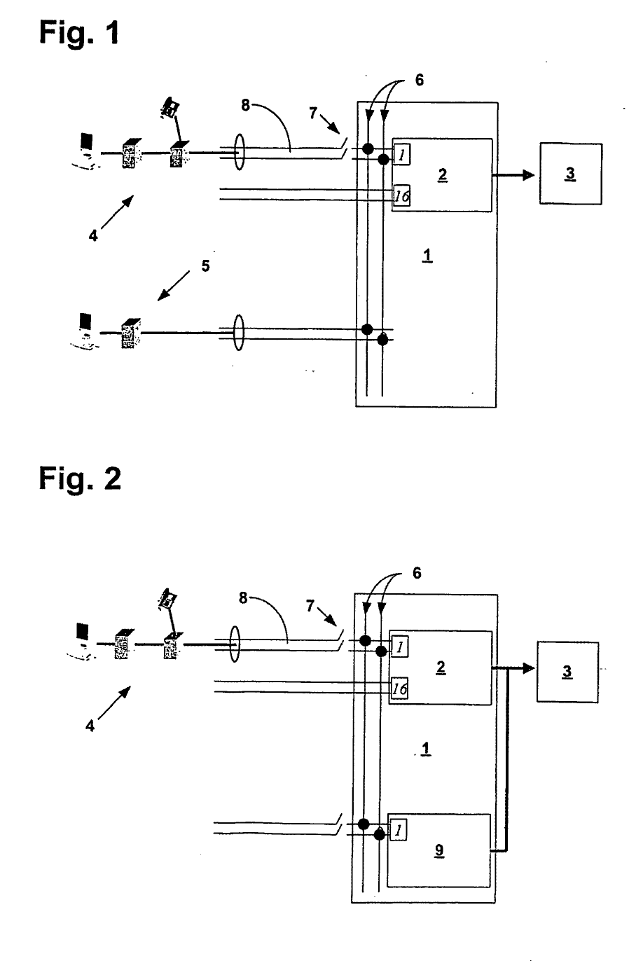

FIG. 1 shows a schematic diagram of a line card carrier 1 on the exchange side of an ADSL connection. The line card carrier 1 has a line card 2, featuring sixteen line ports. Line port 1 is connected via a 2-wire line 8 to an end subscriber 4.

If, despite this physical connection to end subscriber 4 there is no active data communication, the exchange-side line card 2 in the line card carrier 1 must be tested, at least as regards its port 1. This is done by disconnecting the physical connection to subscriber 4 with the aid of a relay 7 and instead establishing a physical connection via the test bus 6 to a test device to be connected 5. This test device is not located on the line card carrier 1 but is special equipment developed for the purpose which is connected if necessary to the test bus of the desired line card carrier 1. Line cards 2 in line card carrier 1 are controlled via a control unit 3 which creates the connection to the desired line port and the test device via a corresponding circuit of switching matrices.

Such a measure is expensive as regards demand for personnel and also requires a sufficient number of appropriate test devices 5 to be kept available.

Thus, in accordance with the invention, as shown in FIG. 2, at least one line card 9 is used in a line card carrier 1 which has at least one line port—shown here as line port No. 1—connected to test bus 6, so that with the aid of control device 3 for testing line port 1 on line card 2 a direct connection between the line ports 1 of the two cards 2 and 9 is established, in which case it is simultaneously ensured via control unit 3 that the chipset of the line card 9 is supplied with software which makes it possible for line card 9 to simulate a subscriber-side modem. This basically now allows a data connection to be established between port 1 of line card 9 and port 1 of line card 2.

If a connection is now actually established between these two ports, line port 1 of the line card 2 is operable and the fault established must be looked for either on the 2-wire line 8 to the subscriber 4 or at the subscriber 4 itself. Should the connection not be established between line card 9 and line card 2 the fault is to be looked for on line card 2 so that this must either be exchanged or replaced.

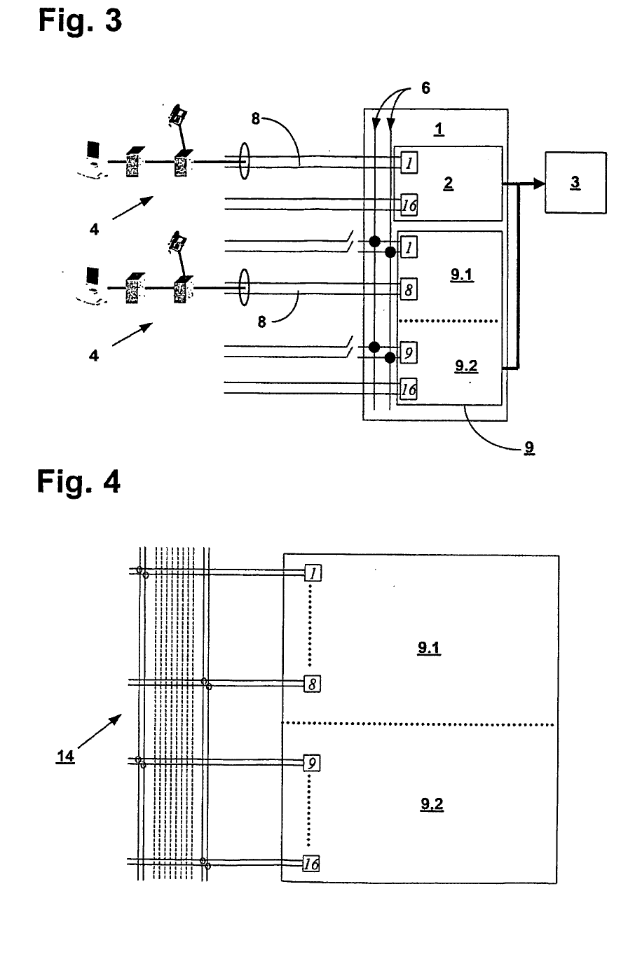

FIG. 3 shows a further variant of the method in accordance with the invention. Here line card 9 has two chipsets which operate a first part 9.1 of the line ports 1 to 8 or a second part 9.2 of the line ports 9 to 16 respectively. This now makes it possible for line card 9 to be operated with the aid of the two separate subareas 9.1 and 9.2 by a connection of a line port in part 9.1 to a line port in part 9.2—shown here by the ports 1 und 9—to conduct a self-test, in which for example the chipset assigned to part 9.1 is loaded with the software for an exchange-side modem while the chipset of the 2nd part 9.2 is operated with software which simulates a subscriber-side modem, so that—as shown here—line ports 1 and 9 are interconnected and when a connection is successfully established between these two ports the operability of the ports is verified or with an unsuccessful connection the fault can be pinpointed to the line card itself.

Naturally a possible in this configuration for line card 9 to also be able to test other line cards on the same line card carrier by the appropriate connection to test bus 6.

FIG. 4 shows an example of executing a test connector for a line card 9 with two chip sets, which divide a line card 9 into two separate areas 9.1 und 9.2. The test connector 14 is embodied such that the first eight line ports 1 to 8 in each case which belong to the first chipset are connected with a line port of the second part of the line card in each case, so that the operability of the corresponding ports can be tested by establishing a connection between the line ports assigned to each other in each case.

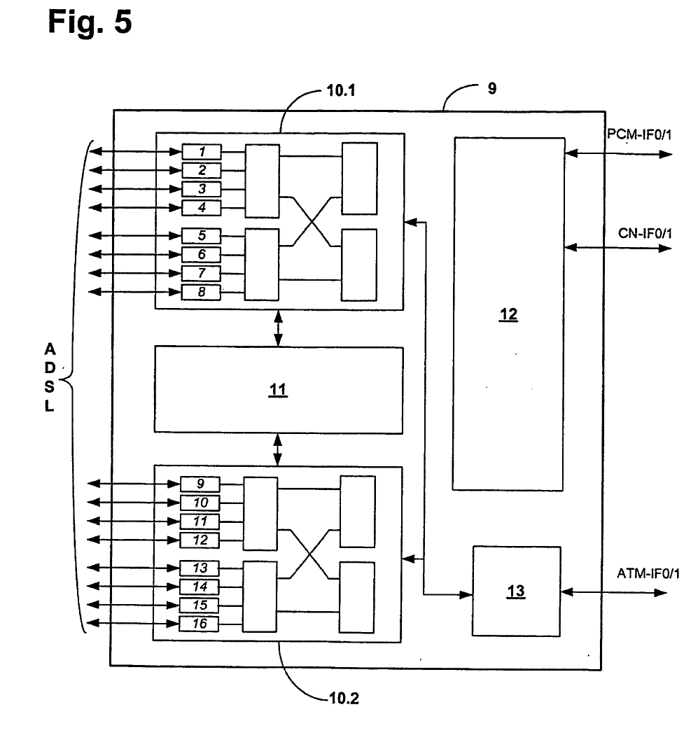

Structure or of such an ADSL line card 9 is shown schematically in FIG. 5. FIG. 5 shows ADSL line card 9 which has two IVAX chipsets 10.1 and 10.2 which are controlled via a controller 11. Both chipsets can be loaded with different software so that the line ports 1 to 8 or 9 to 16 respectively connected to them either fulfill the requirements of an exchange-side modem—this is the standard situation—or the requirements of a subscriber-side modem—for test purposes. This makes it possible, with the aid of the corresponding coupling of the line ports to each other either to conduct self-tests within a line card as regards the line ports or, if coupling is established with other line ports, to also test further line ports within the same line card carrier.

It goes without saying that the features of the invention specified here can be used not just in the given combination but also in other combinations or on their own, without leaving the framework of the invention.

1.-8. (cancelled)

9. A method for testing out exchange-side xDSL line cards in a line card carrier having at least two line cards, comprising:
providing at least one line card having at least one chipset which can be operated with the same bandwidth in both the upstream direction and the downstream direction;
providing a least one line port for a line card;
establishing an electrical connection of a line port to be tested via a test bus to a further testing line port which can be operated in the upstream und downstream direction with the same bandwidth; and
loading the testing line port with software which simulates a subscriber-side modem,
wherein a successfully established connection between the line ports represents a confirmation that the line port to be tested is operable.

10. A method in accordance with claim 9, wherein the line port to be tested and the testing line port are located on different line cards.

11. A method in accordance with claim 9, wherein the line port to be tested and the testing line port are located on the same line card.

12. A method in accordance with claim 9, wherein each of the line cards comprises sixteen line ports.

13. A method for testing out xDSL line cards having at least two programmable chipsets which can be operated both in the upstream direction and also in the downstream direction with the same bandwidth and which operate at least one line port in each case, comprising:
establishing a line connection to at least one line port to be tested of a first chipset with at least one further testing line port of another chipset which can be operated in the upstream and downstream direction with the same bandwidth, on the same line card; and
loading the testing line port with software which simulates a subscriber-side modem, wherein a successfully established connection between the line ports represents a confirmation that the line port to be tested is operable.

14. A line card carrier, comprising:
a plurality of xDSL line cards, wherein a line card has a line port;
a test bus; and
a control, wherein the control can optionally interconnect the line ports of the line cards and can simultaneously disconnect their connection to a subscriber line for test purposes.

15. A line card carrier according claim 14, wherein a line card has sixteen line ports.

16. A cross connector for testing out line cards having at least two independent chipsets for operating the line cards with a high bandwidth in the downstream and upstream direction, wherein at least one port of a chipset is connected to a port of the other chipset.

17. A line card, comprising:
at least one programmable chipset for operating the line card and controlling data transmission; and
a mechanism for executing a method for testing out exchange- side xDSL line cards in a line card carrier having at least two line cards, the method comprising:
providing at least one line card having at least one chipset which can be operated with the same bandwidth in both the upstream direction and the downstream direction;
providing a least one line port for a line card;
establishing an electrical connection of a line port to be tested via a test bus to a further testing line port which can be operated in the upstream und downstream direction with the same bandwidth; and
loading the testing line port with software which simulates a subscriber-side modem, wherein a successfully established connection between the line ports represents a confirmation that the line port to be tested is operable.

18. A computer program product having program code means for executing a method for testing out exchange-side xDSL line cards in a line card carrier having at least two line cards, the method comprising:
providing at least one line card having at least one chipset which can be operated with the same bandwidth in both the upstream direction and the downstream direction;
providing a least one line port for a line card;
establishing an electrical connection of a line port to be tested via a test bus to a further testing line port which can be operated in the upstream und downstream direction with the same bandwidth; and
loading the testing line port with software which simulates a subscriber-side modem, wherein a successfully established connection between the line ports represents a confirmation that the line port to be tested is operable.

19. A computer program product according claim 18, wherein the program code means are executed on a line card.

20. A computer program product according claim 18, wherein the computer program product is operatively adapted to a data carrier.
